(19) United States
(12) Patent Application Publication
(10) Pub. No.: US 2011/0180642 A1
(43) Pub. Date: Jul. 28, 2011

(54) Portable combination horizontal grinder mixer

(76) Inventor: Leon R. Newswanger, Woodbury, PA (US)

(21) Appl. No.: 12/657,626

(22) Filed: Jan. 26, 2010

(51) Int. Cl. B02C 21/02; B02C 9/04; B02C 13/04; B02C 13/286; B02C 11/00

(52) U.S. Cl. 241/101.3; 241/101.6; 241/101.8; 241/101.76

(57) ABSTRACT

A combination portable horizontal grinder mixer for processing a variety of grains includes a housing that includes an upwardly opening lid and which defines and encloses therein a mixing chamber having a horizontally disposed reel-type mixer extending therethrough for simultaneously tumbling and mixing the grains and a spiraled auger that pushes the grain toward the rear of the housing for conveyance through a discharge auger that communicates with the mixing chamber and thence into a storage bin and interconnected to the housing is an infeed chute for delivering grain to a hammer mill that processes grain that requires milling before the grain can be fed into the mixing chamber with the reel-type mixer within the housing being horizontally oriented so that the mixer has greater capacity, eliminates bridging and has a low center of gravity for stable transport.

### FIELD OF THE INVENTION

The present invention pertains to farm processing equipment, and more particularly pertains to a piece of farm equipment machinery designed to grind, mill, mix and transport a variety of grains.

### BACKGROUND OF THE INVENTION

The operation of a farm, whether small, medium or large-scale, requires the use of numerous types and kinds of equipment. Irrespective of whether the farm is primarily a dairy farm, a cattle farm, or an agricultural farm, the various and numerous pieces and types of farm equipment are each designed for a specific function and job.

With specific reference to farms that include livestock and animals of any kind, such as goats, chickens, pigs, horses, diary cows, cattle, etc, one of the most critical aspects of raising healthy stock pertains to the proper processing of the feed grain and other products—minerals, vitamins, supplements—for the animals. The processing of the material can include grinding, milling, mixing, distribution and, in many cases, the transport of the material to other sites, locations, farms, etc., and the processing of the feed material must be thorough to assure mix uniformity as the various types of grains are all non-uniform in shape and configuration before processing.

The type of farm equipment used to process the various types and kinds of feed material is a grinder mixer having a vertically extending mixing chamber and a tapering or cone-shaped bottom. The vertically oriented mixing chamber is supported and mounted on a frame or carriage that includes two pairs of wheels for transport. Extending upwardly from the cone-shaped bottom is a vertical mixing auger. Despite the popularity of vertical mixing augers they have a number of defects. First, bridging of the material being mixed is common, especially when the material is damp and/or bulky. Second, the vertically oriented mixing auger is unstable in transport due to the high center of gravity. Also, capacity within the mixing chamber is limited due to the height restrictions (imposed for safety and ease of material unloading). Finally, the configuration of the vertically oriented mixing auger—it is too high and the wrong shape—makes is difficult to load with loader equipment, and there is less reach with the unload. auger—the length of the unload auger is limited—due to interference of the tractor cab. Thus, the prior art discloses a number of devices that attempt to rectify these shortcomings.

For example, the Henkensiefken et al. patent (U.S. Pat. No. 4,432,499) discloses a portable feed grinder-mixer that includes a pair of complementing horizontal and vertical augers.

The Seymour patent (U.S. Pat. No. 4,561,781) discloses an agricultural feed blending apparatus that includes a plurality of bins for different feed materials, variable speed metering augers and a mixing augur beneath the bins for transferring the mixed material to a grinding unit.

The Seymour patent (U.S. Pat. No. 4,577,805) discloses an agricultural mixing and grinding machine that includes a plurality of bins each containing different feed material with each bin having a metering auger for discharging the material to a common. location.

The High, Jr. et al. patent (U.S. Pat. No. 4,765,747) discloses a feed mixing apparatus that includes a tank enclosing therein bottom and upright augers.

The Miller patent (U.S. Pat. No. 5,240,321) discloses a vertical screw mixer that includes a container having an opening and a plurality of generally conical processing screws.

The McGuffin et al. patent (U.S. Pat. No. 5,607,113) discloses a mixer-grinder having an upwardly angled trough ergonomically designed with regard to the discharge opening, cleaning purposes and the location of the worm.

The Rhee patent (U.S. Pat. No. 6,267,497 B1) discloses a pair of chambers with each chamber having a pair of inclined mixing/feeding units for producing feed stuff or organic fertilizer from edible waste material such as domestic and commercial food waste products.

The Neier et al. patent (U.S. Pat. No. 6,923,393 B1) discloses a horizontal feed mixer and method that includes two horizontal augers located above a rotor all rotating in the same direction and enclosed in a chamber for cutting product such as hay and other feed ingredients.

Nonetheless, despite the ingenuity of the above devices, there remains a need for a horizontal, reel-type mixing chamber that allows the farmer to auger the finished product into a storage bin.

### SUMMARY OF THE INVENTION

The present invention comprehends a piece of farm equipment machinery that is designed to process feed material including, but not limited to, the grinding, milling, mixing and transporting of various feed grains, vitamins, and minerals for eventual consumption by livestock. More specifically, the farm equipment machinery is a combination portable hammer mill and horizontal bar reel mixer that grinds, mixes, blends, and mills the many and varied types of livestock feed grain, vitamins, and minerals.

The combination portable horizontal grinder mixer of the present invention includes a housing defining and enclosing therein a mixing chamber. The housing is mounted on a chassis or framework having front and rear wheels for transport from site to site. The housing includes a roof part of which is openable to allow for top loading of the material and a discharge door at the lower part of the rear wall of the mixing chamber so allowing the mixing chamber to communicate with a discharge auger that feed the material into a storage bin. The discharge auger extends upwardly alongside the rear wall and across the top of the mixing chamber with the discharge nozzle extending past the front of the mixing chamber. The discharge auger is able to tilt and pivot to reach storage bins for the unloading the material therein. Located in front of the mixing chamber and in communication with the mixing chamber is a connecting conduit member and enclosed within the connecting conduit member is an intake auger that forces the material into the mixing chamber. A hammer mill is contained within the hammer mill housing and is used to process grains that require milling whereupon the milled grains are augered into the mixing chamber. The hammer mill housing registers with and is connected to the connecting conduit member. An infeed chute is mounted to and extends upwardly from the hammer mill housing and register with the hammer mill housing. An infeed auger is located within the infeed chute and the infeed auger lifts the material—grain—into the hammer mill. Enclosed within the mixing chamber are at least two mixing and moving means for processing and discharging the various types of grains. Extending through the mixing chamber of the housing is a horizontally disposed reel-type mixer, commonly referred to as a bar reel, and located adjacent to the inside of one sidewall is an auger spiraled to push the processed grain towards the rear of the housing so that the grain can be conveyed through the discharge auger and into the storage bin. The reel-type mixer is of a spiral configuration and simultaneously tumbles, mixes, and moves the grain toward the front of the mixing chamber for eventual movement rearward by the spiraled auger for conveyance through the discharge auger for deposition into the storage bin. Disposed within the mixing chamber is a measurement scale that is electronically interconnected to an electronic scale reader externally mounted to one sidewall for immediately and visually registering the weight of the material deposited within the mixing chamber. A PTO (power take-off) shaft driven by tractor power powers for elements such as the hammer mill and the intake auger.

It is an objective of the present invention to provide a combination horizontal grinder mixer that has a low center of gravity to facilitate the stable transport of the combination grinder mixer;

It is another objective of the present invention to provide a combination horizontal grinder mixer that has a greatly increased capacity with respect to standard and existing vertically oriented grinder mixers having vertical mixing augers;

It is yet another objective of the present invention to provide a combination horizontal grinder mixer that has a low height and rectangular configuration that allows for top loading with a loader tractor;

It is still another objective of the present invention to provide a combination horizontal grinder mixer that allows for greater capacity to load and unload due to the auger length;

It is still yet another objective of the present invention to provide a combination horizontal mixer grinder that allows for more flexibility in the types and kinds of materials that are to be mixed;

It is still yet a further objective of the present invention to provide a combination horizontal grinder mixer having a design and configuration that provides for a more balance in loaded transport situations;

Another objective of the present invention is to provide a combination horizontal grinder mixer that is able to grind, mill, mix, blend, process and transport many varied types of livestock feed grain, vitamins, and minerals;

Still another objective of the present invention is to provide a combination horizontal grinder mixer that provides for a simultaneous and continuous tumbling of the material as well as an end to end mixing of the material and avoids bridging of the material within the mixing chamber because of the low height and rectangular configuration of the grinder mixer;

Yet another objective of the present invention is to provide a combination horizontal grinder mixer that provides for the bi-directional tumbling and movement of the material within the mixing chamber;

Still yet another objective of the present invention is to provide a combination horizontal grinder mixer that combines a hammer mill with a portable, horizontal reel-style mixer;

Still yet a further objective of the present invention is to provide a combination horizontal grinder mixer that includes an electronic scale for weighing the amount of material such as the various grains that are deposited in the mixing chamber for processing;

A further objective of the present invention is to provide a combination horizontal grinder mixer that includes a discharge or unload auger having an increased length and doesn't interfere with the tractor cab and which is capable of both hydraulically actuated pivotable and tilting movement allowing for a higher reach into taller bins; and

A yet further objective of the present invention is to provide a combination horizontal grinder mixer that can be used on small, medium and large scale farm and dairy establishments that includes, but are not limited to, dairy, beef, hog and chicken farms.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the combination horizontal grinder mixer of the present invention;

FIG. 2 is a side elevational view of the combination grinder mixer of the present invention illustrating the disposition of the structural elements within the mixing chamber;

FIG. 3 is rear sectioned elevational view of the combination grinder mixer of the present invention taken along lines 3-3 of FIG. 2 illustrating the disposition of the structural elements contained within the mixing chamber from a rear view;

FIG. 4 is a sectioned elevational view of the combination grinder mixer of the present invention illustrating the rotational orientation of the longitudinal bar reel and the tumbling orientation and direction of the feed product or food material;

FIG. 5 is a sectioned elevational view of the combination grinder mixer of the present invention illustrating the bi-directional movement of the feed, food product or material within the mixing chamber whereby the material is continuously pushed and moved from the back to the front and then from the front to the back of the mixing chamber for conveyance to a storage bin;

FIG. 6 is a side elevational view of the combination grinder mixer of the present invention illustrating the pivotal movement of the discharge auger from the rest position to a lateral rearward discharge position; and

FIG. 7 is a representative flowchart of the combination grinder mixer of the present invention illustrating the series of processing steps undertaken when using the mixer grind

### DETAILED DESCRIPTION OF THE PREFERRED EMBODIMENT

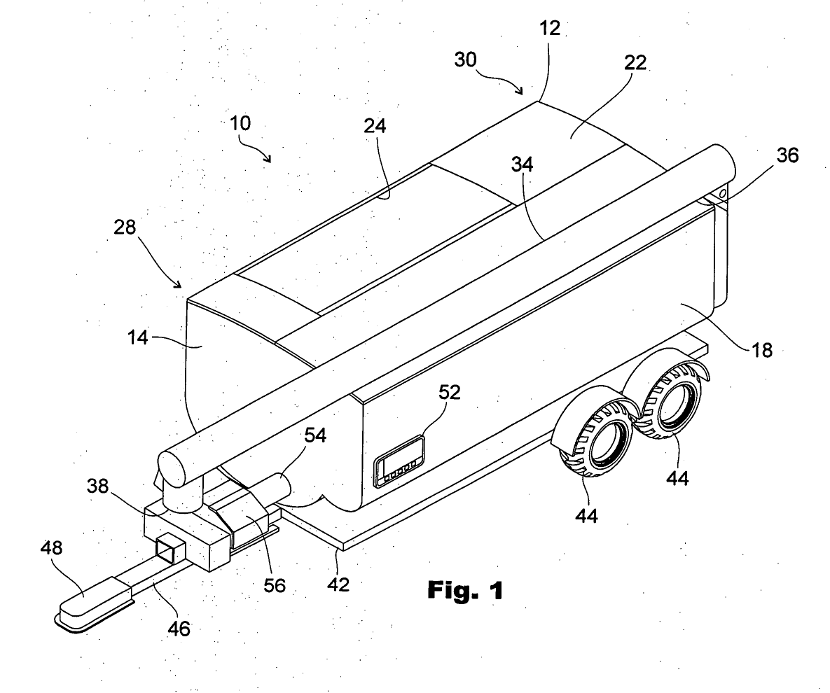

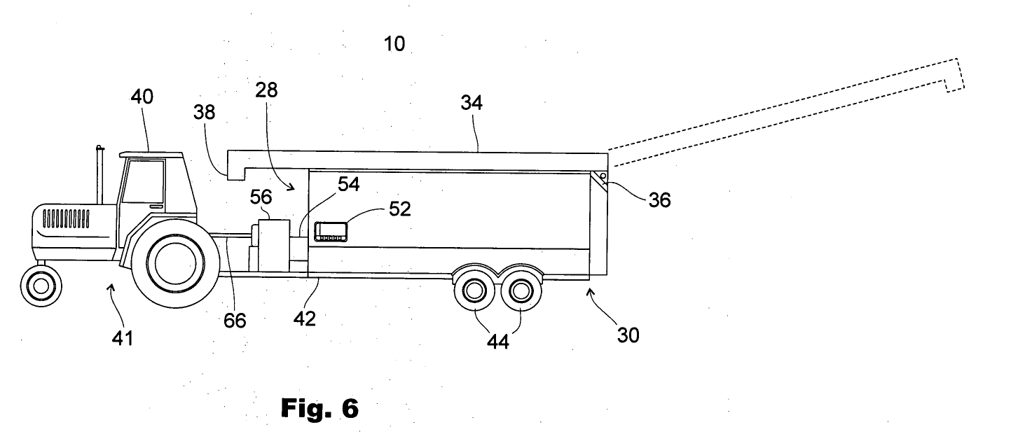

Illustrated in FIGS. 1-7 is a horizontally oriented grinder mixer 10 for processing a wide variety of material 11 or product such as feed grains, livestock grains, vitamins, minerals, supplements, etc., through grinding, milling, and mixing so that the material 11 is thoroughly processed before being directed and discharged into some type of receptacle or storage container such as a storage bin. The grinder mixer 10 of the present invention provides for the constant and simultaneous tumbling of the material 11 as well as the end to mixing of the material 11. In addition, the grinder mixer 10 of the present invention is designed to prevent the bridging of the material 11; the intermixing of material 11 that has been processed with material 11 that has not been processed by the constant tumbling action.

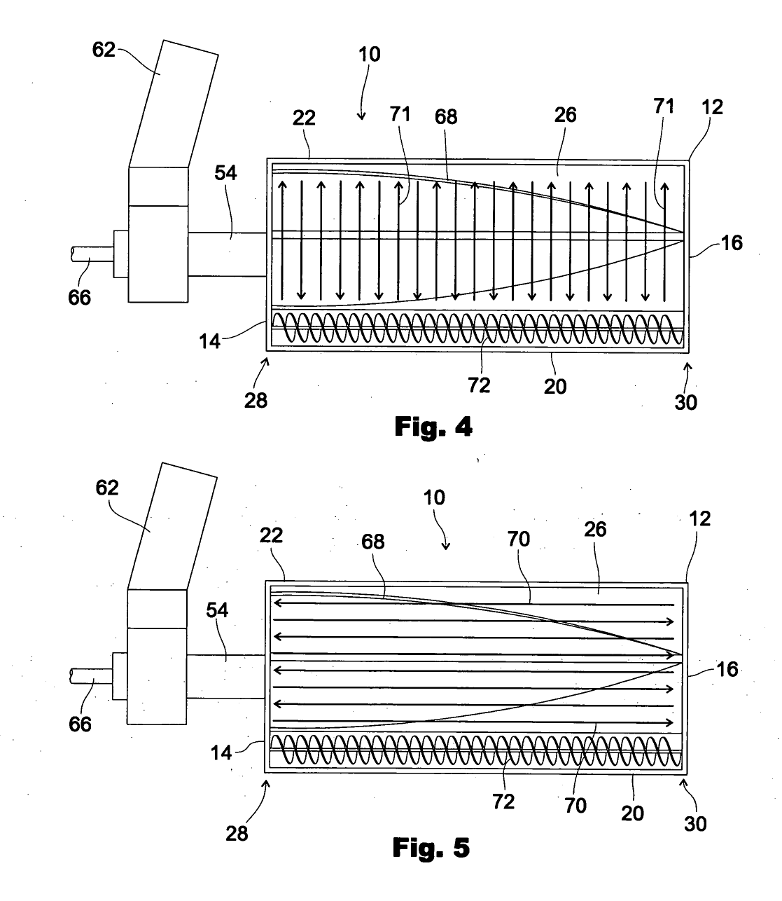

Thus, as shown in FIGS. 1-7, the grinder mixer 10 includes a horizontally shaped, extending or configured housing or container 12. The housing 12 includes a front wall 14, a rear wall 16, a pair of opposed sidewalls 18, and an arcuate or curved floor or bottom 20, and a roof 22 with the roof 22 being partially of fully openable by including a roll tarp top or a hinged lid 24. This allows for direct top loading of the material 11 by a loader bucket; a special concentrate hopper can also be used to load material. The housing 12 further defines an interior mixing chamber 26 that is also horizontally shaped or configured. The material 11 is loaded into the mixing chamber 26 for processing therein through the constant tumbling and mixing action. In addition, the housing 12 and the interior mixing chamber 26 are further defined by having or delineating a front 28 and a rear 30. Located at the lower end of the rear wall 16 of the housing 12 is a discharge door 32 that interconnects the interior mixing chamber 26 to structure hereinafter further described. Mounted to the rear wall 16 and interconnected to and in communication with the interior mixing chamber 26 is an unloading or discharge auger 34. The discharge auger 34 extends upwardly alongside the rear wall 16 and alongside and immediately above the roof 22 toward the front 28 of the mixing chamber 26. A hydraulic lift 36 is mounted to the roof 22 at the rear 30 thereof and connects to the discharge auger 32 and is used to tilt and pivot the discharge auger 34 from a non-use transport position to a use and unload position. The discharge auger 34 is actuated by the hydraulic lift 36 for pivoting and tilting movement to unload the material 11 into the storage means such as the aforementioned storage bin. FIG. 1 illustrates the discharge auger 32 in the rest, transport or non-use disposition and FIG. 4 illustrates the discharge auger 32 in the pivoting position for unloading material 11 from the mixing chamber 26. The extended length of the discharge auger 34 allows it to extend along and above the roof 22 and projects past the front 28 of the housing 12 whereupon the nozzle 38 is located between the front 28 of the housing 12 and the cab 40 of a vehicle 41 such as a tractor and the length of the discharge auger 32 allows for a higher reach into tall storage bins. The housing 12 is supported on a carriage or framework 42 that includes at least one pair of wheels 44 and the present embodiment includes two pairs of wheels 44. A hitch bar 46 extends horizontally from the carriage 42 and includes a hitch 48 for attaching to the hitch ball of the vehicle 41 for towing and transporting the grinder mixer 10 from site to site.

As shown in FIGS. 1 and 3 the grinder mixer 10 includes a means to determine the weight of the material 11 deposited in the interior mixing chamber 26. The weight determining means includes a scale 50 incorporated with the floor 20 of the housing 12 and which is electrically interconnected to an electronic scale reader 52 externally mounted to one sidewall 18 and which immediately and visually registers the weight of the material 11 held within the mixing chamber 26 of the housing 12.

As shown in FIGS. 1, 2, 4, 5, and 6, a circular connecting conduit member 54 is secured to the front wall 14 of the housing 12 and communicates with the mixing chamber 26 of the housing 12. A hammer mill housing 56 is connected to the connecting conduit member 54 and is communication therewith. Contained within the connecting conduit member 54 is an intake auger 58 which may also be considered to be located at the bottom of the hammer mill housing 56 but not actually contained within the housing 56. The intake auger 58 conveys the material 11 into the mixing chamber 26 for processing. A hammer mill 60 is contained within the hammer mill housing 56 and is used to process material 11 such as grains that first need milling before being augered by the intake auger 58 into the interior mixing chamber 26. Extending upwardly from the hammer mill housing 56 and connected to and in communication therewith is an infeed chute 62 that contains or encloses therein an infeed auger 64. The infeed auger 64 lifts or conveys grain into the hammer mill housing 56 for processing by the hammer mill 60. Extending from the tractor 41 rearward to the hammer mill housing 56 is a PTO (power take-off shaft) 66 that is driven by tractor power and that may be used to power elements such as the hammer mill 60 and the intake auger 58.

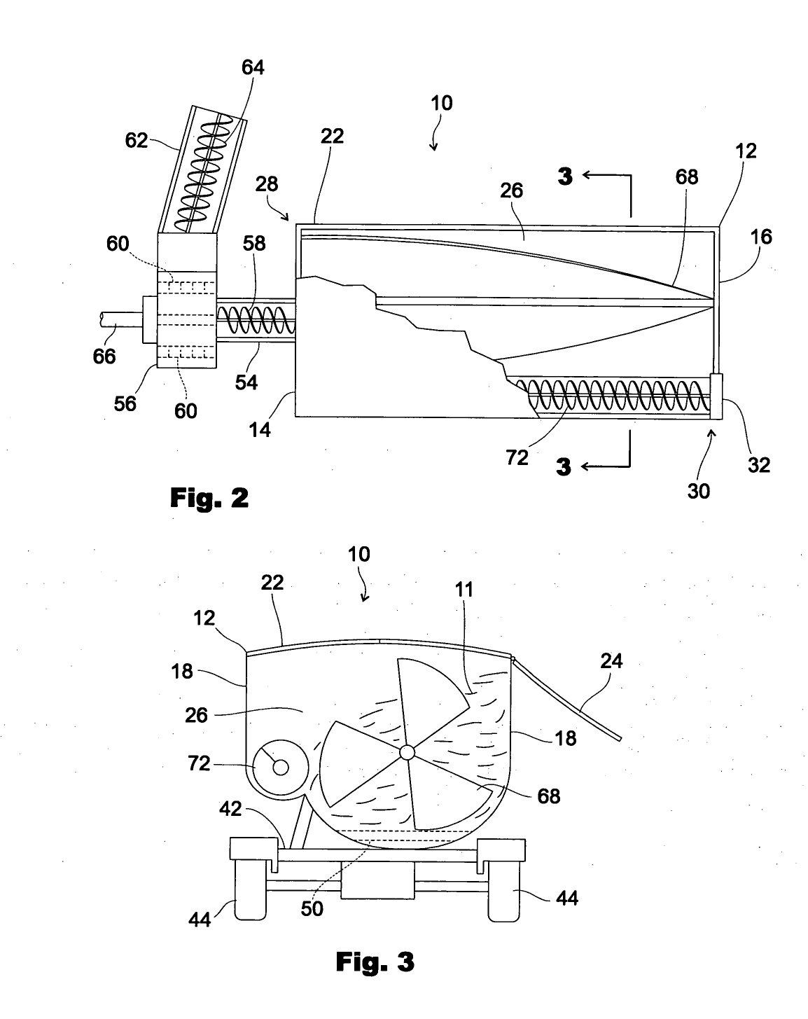

As shown in FIGS. 2, 4 and 5, the grinder mixer 10 includes a means for continuously tumbling and mixing the material 11 within the mixing chamber 26. The means for tumbling and mixing is configured to avoid bridging of material 11 so that the material 11 is processed in a uniform and thorough manner. The means for tumbling and mixing includes a reel mixer 68 such as a reel-type mixer that extends through the mixing chamber 26 from the rear wall 16 to the front wall 14. It is actuated by any standard motive means interconnected to the PTO 66. The reel-type mixer 68 is horizontally oriented and can be of any desired configuration such as a spiral reel type, a paddle reel type, a ribbon reel type, etc. In the present embodiment the reel-type mixer 68 is a spiraled bar reel that tumbles the material 11 as well as forcing the material 11 toward the front 28 of the mixing chamber 26. Shown in FIGS. 4 and 5 are longitudinal or horizontal directional arrows 70 that indicate both the tumbling action or movement and the horizontal movement of the material 11 within the mixing chamber 26 effectuated by the reel mixer 68. In addition, the material 11 is tumbled and mixed in an up-and-down or essentially vertical orientation as shown by directional arrows 71 in FIG. 4 also by the action of the reel mixer 68. The reel-type mixer 68 extends the complete horizontal length of the mixing chamber 26 and is rotatably mounted to the inside surfaces of the rear wall 16 and the front wall 14 and is centrally located within the mixing chamber 26. The reel mixer 68 continuously and simultaneously tumbles the material 11 within the mixing chamber 26 and also forces the material 11 toward and to the front 28 of the mixing chamber 26 where the material 11 moves to a spiraled secondary auger 72 to be force fed back to the rear 30 of the mixing chamber 26 for conveyance through the discharge door 32 and thence through the unloading/discharge auger 34. As illustrated in FIGS. 2-5, the grinder mixer 10 also includes the horizontally oriented secondary auger 72 positioned adjacent one sidewall 18 and to one side of the bar reel mixer 68. The secondary auger 72 is spiraled to move the material 11 rearward toward and thence through the discharge door 32 for conveyance through the discharge auger 34 and thence into the storage bin. Thus; mixing reel 68 extending through the mixing chamber 26 subjects the material 11 to bi-directional movement within the mixing chamber 26 without causing the bridging of the material 11 so that the material 11 is thoroughly mixed and processed.

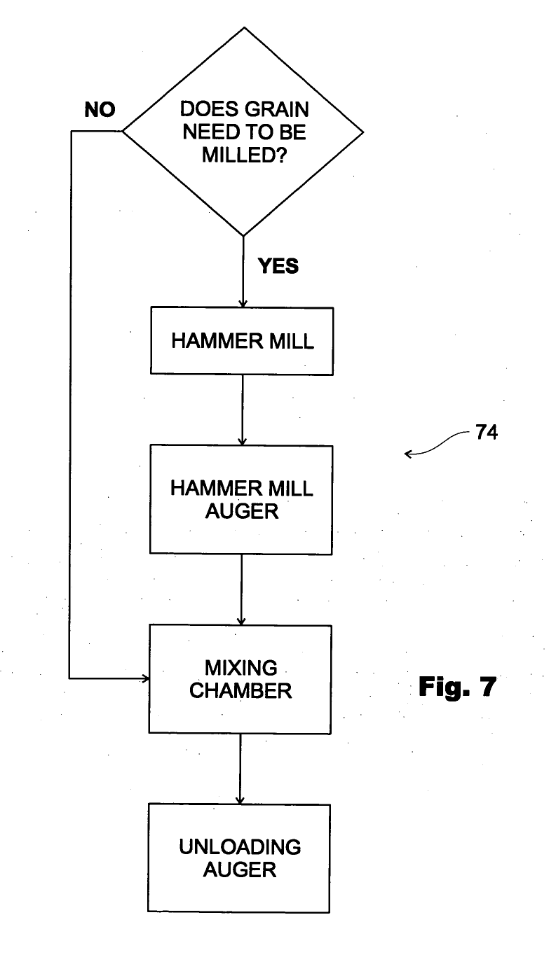

Illustrated in FIG. 7 is a representative schematic or flowchart 74 for the processing steps involved in the grinding and processing of the material 11 within the mixing chamber 26. The first step requires an answer to the question of whether the material 11—the grain—needs milling. If the answer is no then the material 11 can be directly deposited into the mixing chamber 26 by any of the aforedescribed means; and after thorough mixing the material 11 is unloaded by the discharge auger 34. On the other hand, if the material 11—the grain—needs to be milled, then the material 11 is first fed into the hammer mill 60 and after sufficient processing the material 11 is fed into the mixing chamber 26 by the intake or hammer mill auger 58, and after thorough mixing in the mixing chamber 26 the material 11 is forced by the spiraled auger 72 to the discharge or unloading auger 34 for unloading from the mixing chamber 26 and into the storage bin.

While the invention has been shown and described in a preferred embodiment, it will be apparent to those skilled in the art that numerous alterations, modifications, and variations will possible and practicable without departing from the spirit and scope of the invention as set forth by the appended claims.

I claim:

1. A portable grinder mixer for grinding and mixing material so that the material can be properly stored in the storage container, comprising:
a horizontally configured elongated housing having a floor, a roof, a front wall a rear wall and opposed sidewalls;
the housing defining a front and a rear and an interior mixing chamber;
a pivotable elongated discharge auger secured to the rear of the housing and selectively pivotable between a non-rest disposition and a discharge disposition;
a reel mixer horizontally extending through the mixing chamber from the front to the rear of the housing for continuously tumbling and mixing the material disposed within the mixing chamber and for pushing the material toward the front of the housing;
a secondary auger horizontally extending through the mixing chamber from the rear to the front and located adjacent one sidewall with the rotation of the secondary auger causing the material to be pushed toward the rear of the housing so that the material is pushed from the mixing chamber to the discharge auger for unloading to the storage container;
an infeed auger located at the front of the housing and interconnected to the housing and in registration with the mixing chamber for conveying material thereto;
a hammer mill located between the infeed auger and the housing and in communication with the infeed auger and the mixing chamber for processing material that requires milling before the material can be conveyed into the mixing chamber; and
the reel mixer processing the material conveyed and loaded into the mixing chamber by tumbling the material both horizontally and in an up and down motion while concomitantly moving the material toward the front of the housing whereupon the secondary auger forces the material toward the rear of the housing for conveyance through the discharge auger and unloading therefrom into a storage container.

2. The portable grinder mixer of claim 1 wherein the roof further includes a hinged lid that is selectively openable and closable for allowing material to be loaded into the interior mixing chamber.

3. The portable grinder mixer of claim 2 wherein the rear wall includes a discharge door that allows the conveyance of material from the interior mixing chamber to the discharge auger.

4. The portable grinder mixer of claim 3 further comprising a scale disposed within the interior mixing chamber and adjacent the floor of the housing.

5. The portable grinder mixer of claim 4 further comprising an electronic scale mounted to one of the sidewalls and which is electronically interconnected to the scale for visually registering the weight of the material loaded within the interior mixing chamber of the housing.

6. A portable grinder mixing for grinding and mixing grain so that the grain can be stored in the storage container, comprising:
a horizontally extending elongated housing;
the housing defining a front and a rear and an interior storage chamber;
a pivotable elongated discharge auger mounted to the rear of the housing and selectively pivotable between a non-use disposition and a discharge disposition;
a reel mixer horizontally extending through the mixing chamber for continuously tumbling and mixing the grain loaded within the mixing chamber and for pushing the grain toward the front of the housing;
a secondary auger horizontally extending through the mixing chamber and located adjacent one sidewall with the rotation of the secondary auger causing the grain to be pushed toward the rear of the housing for unloading into the storage container by the discharge auger;
an infeed auger located at the front of the housing and interconnected to the housing and in registration with the mixing chamber for conveying grain thereinto;
a hammer mill located between the infeed auger and the housing and in registration with the infeed auger and the mixing chamber for processing grain that requires milling before the grain can be conveyed into the mixing chamber; and
the reel mixer processing the grain that has been loaded into the mixing chamber by simultaneously tumbling and mixing the grain both horizontally and in an up and down motion within the mixing chamber while concomitantly moving the grain toward the front of the housing so that, the secondary auger can force the grain toward the rear of the housing for conveyance to the discharge auger whereupon the discharge auger unloads the grain into the storage container.

7. The portable grinder mixer of claim 6 wherein the horizontally extending housing includes a floor, a roof, a front wall, a rear wall, and opposed sidewalls.

8. The portable grinder mixer of claim 7 wherein the reel mixer horizontally extends through the interior mixing chamber from the rear wall to the front wall.

9. The portable grinder mixer of clam 8 wherein the secondary auger horizontally extends through the interior mixing chamber from the rear wall to the front wall.

10. The portable grinder mixer of claim 9 wherein the roof further includes a hinged lid that is selectively openable and closable for allowing grain to be loaded into the interior mixing chamber.

12. The portable grinder mixer of claim 11 wherein the rear wall includes a discharge door that allows the conveyance of grain from the interior mixing chamber to the discharge auger.

13. The portable grinder mixer of claim 12 further comprising a scale disposed within the interior mixing chamber and adjacent the floor of the housing.

14. The portable grinder mixer of claim 13 further comprising an electronic scale mounted to one of the sidewalls and which is electronically interconnected to the scale for visually registering the weight of the grain loaded within the interior mixing chamber of the housing.

15. A portable grinder mixer for tumbling, grinding, and mixing grain so that the grain can be stored in the storage container, comprising:
a horizontally extending housing having a front and a rear;
the housing defining an interior storage chamber;
a pivotable and tiltable discharge auger mounted to the housing and selectively pivotable and tiltable between a non-use disposition and a grain discharge disposition;
a reel mixer horizontally extending through the interior storage chamber for continuously tumbling and mixing the grain loaded within the interior storage chamber and for pushing the grain to the front of the housing;
a secondary rotatable auger horizontally extending through the interior mixing chamber with the rotation of the secondary auger forcing the grain toward the rear of the housing for conveyance through the discharge auger and unloading into the storage container; and
whereupon the reel mixer processes the grain loaded into the interior storage chamber by simultaneously tumbling and mixing the grain through a horizontal and up and down motion while concomitantly moving the grain toward the front of the housing so that the secondary auger can force the grain toward the rear of the housing for conveyance to the discharge auger so that the discharge auger can unload the grain into the storage container.
